(19) United States
(12) Patent Application Publication
(10) Pub. No.: US 2016/0260140 A1
(43) Pub. Date: Sep. 8, 2016

(54) SYSTEM AND METHOD FOR PROVIDING A PROMOTED TRACK DISPLAY FOR USE WITH A MEDIA CONTENT OR STREAMING ENVIRONMENT

(71) Applicant: SPOTIFY AB, Stockholm (SE)

(72) Inventors: Steve Shirley, New York, NY (US); Jay Richman, New York, NY (US); Samwoo E, Eaglewood, NJ (US); Chris Angove, New York, NY (US)

(21) Appl. No.: 15/063,286

(22) Filed: Mar. 7, 2016

Related U.S. Application Data
(60) Provisional application No. 62/129,689, filed on Mar. 6, 2015.

(51) Int. Cl. G06Q 30/02; H04L 29/06

(52) U.S. Cl. CPC G06Q 30/0277; H04L 65/60

(57) ABSTRACT

In accordance with an embodiment, described herein are a system and method for providing a promoted track display for use with a media content or media streaming environment. A media device, operating as a client device, can receive and play media content provided by a media server. An advertisement server can be used to determine advertisements or promoted content to be delivered to the client in connection with the provided media content. One or more promoted tracks, for example songs, music, or other sponsor content, can be surfaced or otherwise displayed at a user interface of the media device via visuals or display queues that are playable upon user-click or other form of selection. Display queues that include promoted tracks can be used to increase promoted track inventory and provide an engaging advertisement format for use by media content partners, for example, music promoters.

### CLAIM OF PRIORITY

This application claims the benefit of priority to U.S. Provisional Patent Application No. 62/129,689, titled “SYSTEM AND METHOD FOR PROVIDING A PROMOTED TRACK DISPLAY FORMAT FOR USE WITH A MEDIA CONTENT OR MEDIA STREAMING ENVIRONMENT”, filed Mar. 6, 2015, which above application is herein incorporated by reference.

### FIELD OF INVENTION

Embodiments of the invention are generally related to the providing of digital media content and advertising, and are particularly related to a system and method for providing a promoted track display for use with a media content or media streaming environment.

### BACKGROUND

Today's consumers enjoy the ability to access a tremendous amount of media content, such as music and videos, at any location or time of day, using a wide variety of media devices. Media content providers, for example music streaming services such as Spotify, are ideally positioned to promote artists' works, and artist-related merchandise or information.

However, there is an ongoing desire for new advertising mechanisms that provide content providers and advertisers with a means of promoting content that is more effective than other formats; while providing users with, for example, music or song recommendations which they feel are relevant to their musical tastes. These are some examples of the types of environments in which embodiments described herein can be used.

### SUMMARY

In accordance with an embodiment, described herein are a system and method for providing a promoted track display for use with a media content or media streaming environment. A media device, operating as a client device, can receive and play media content provided by a media server. An advertisement server can be used to determine advertisements or promoted content to be delivered to the client in connection with the provided media content. One or more promoted tracks, for example songs, music, or other sponsor content, can be surfaced or otherwise displayed at a user interface of the media device via visuals or display queues that are playable upon user-click or other form of selection. Display queues that include promoted tracks can be used to increase promoted track inventory and provide an engaging advertisement format for use by media content partners, for example, music promoters.

### BRIEF DESCRIPTION OF THE FIGURES

FIG. 1 illustrates an example of a system for providing media content, in accordance with an embodiment.

FIG. 2 further illustrates an example of a system for providing media content, in accordance with an embodiment.

FIG. 3 further illustrates an example of a system for providing media content, in accordance with an embodiment.

FIG. 4 illustrates a system for providing a promoted track display for use with a media content or streaming environment, in accordance with an embodiment.

FIG. 5 further illustrates a system for providing a promoted track display for use with a media content or streaming environment, in accordance with an embodiment.

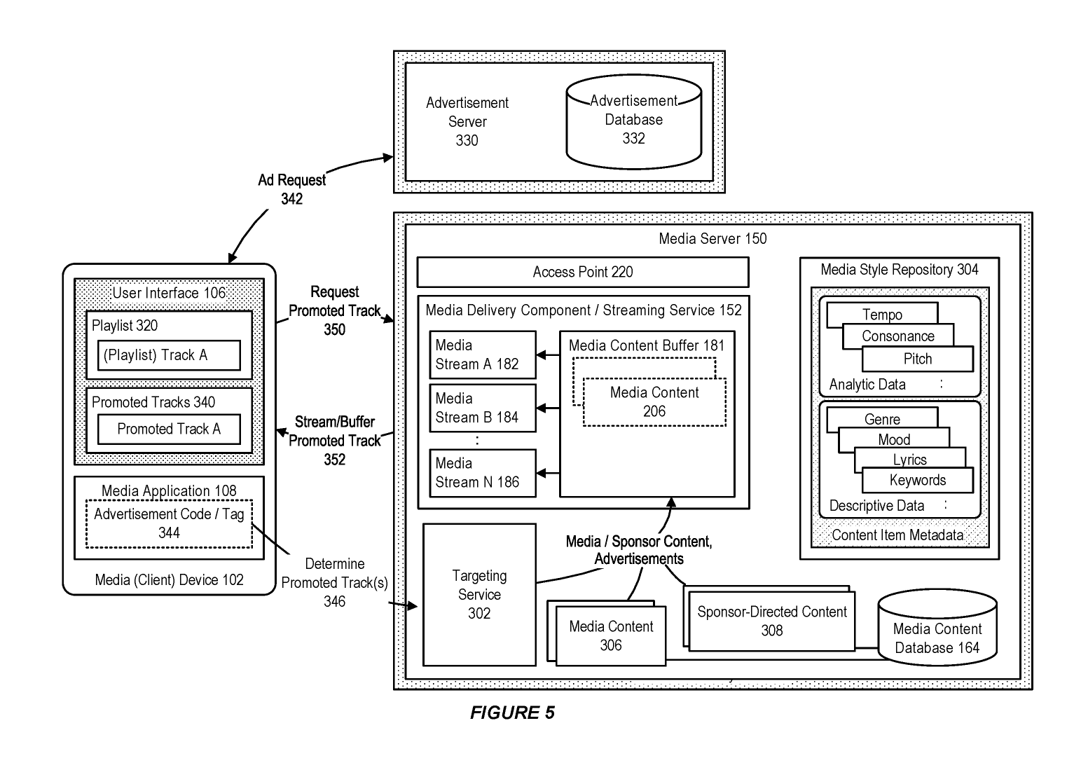

FIG. 6 illustrates an exemplary promoted track display for use with a media content or streaming environment, in accordance with an embodiment.

FIG. 7 illustrates another exemplary promoted track display for use with a media content or streaming environment, in accordance with an embodiment.

FIG. 8 illustrates a process for providing a promoted track display for use with a media content or streaming environment, in accordance with an embodiment.

### DETAILED DESCRIPTION

As described above, today's consumers enjoy the ability to access a tremendous amount of media content, such as music and videos, at any location or time of day, using a wide variety of media devices. Media content providers, for example music streaming services such as Spotify, are ideally positioned to promote artists' works, and artist-related merchandise or information. However, there is an ongoing desire for new advertising mechanisms that provide content providers and advertisers with a means of promoting content that is more effective than other formats; while providing users with, for example, music or song recommendations which they feel are relevant to their musical tastes.

In accordance with an embodiment, described herein are a system and method for providing a promoted track display for use with a media content or media streaming environment. A media device, operating as a client device, can receive and play media content provided by a media server. An advertisement server can be used to determine advertisements or promoted content to be delivered to the client in connection with the provided media content. One or more promoted tracks, for example songs, music, or other sponsor content, can be surfaced or otherwise displayed at a user interface of the media device via visuals or display queues that are playable upon user-click or other form of selection. Display queues that include promoted tracks can be used to increase promoted track inventory and provide an engaging advertisement format for use by media content partners, for example, music promoters.

In accordance with an embodiment, the system comprises a media device having a user interface, that enables a user to select from a plurality of displayed media options to be played at the device, wherein each media option corresponds to a media content item; wherein in response to receiving an advertisement request from a client, an advertisement server causes an advertisement code or tag to be sent to the client, where it can be used to retrieve a promoted track; and wherein one or more promoted tracks are surfaced at the user interface via visual/display queues that are playable upon user initiation/click or other selection.

In accordance with an embodiment, a user can interact with a media device or client, and issue requests to access media content at a media server to stream music, video, or other forms of media content to the media device; and wherein in response, the media server can populate a media content buffer with corresponding items of media or sponsor-directed content, for example as one or more streams of media content and/or advertisement or other sponsor-directed content, and communicate the selected media content to the user's media device.

In accordance with an embodiment, the system includes a targeting service that can determine an appropriate media content and/or sponsor-directed content, for streaming within a particular session.

In accordance with an embodiment, the system can match a promoted track to a playlist that is relevant or to a type of user that is relevant.

The above and additional embodiments are described in further detail below.

### Media Content Environment

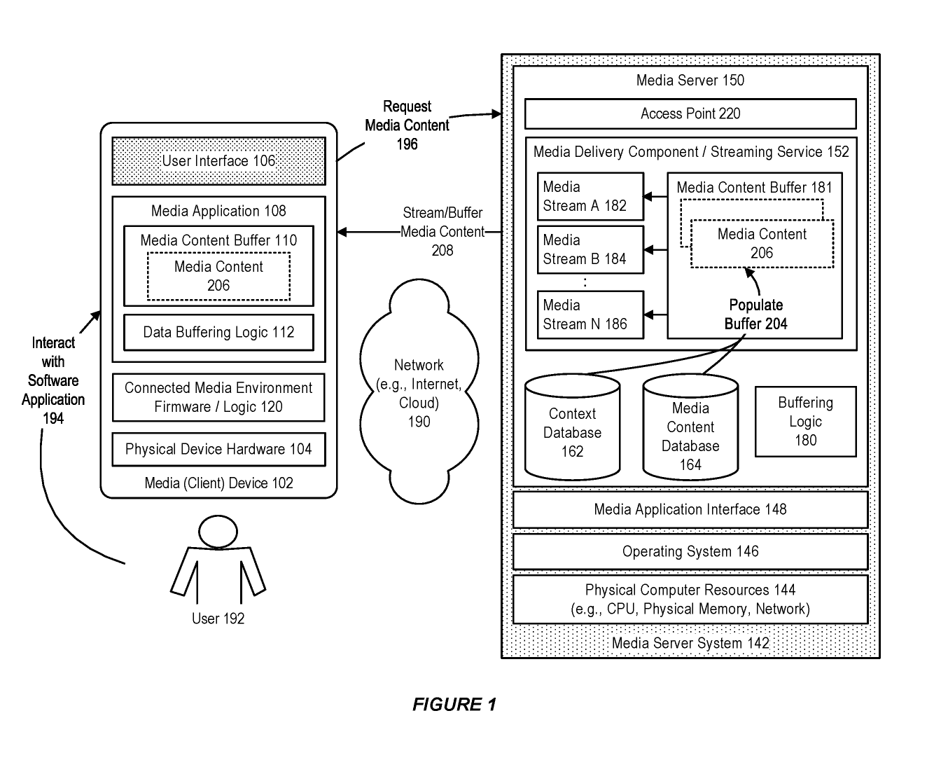

FIG. 1 illustrates an example of a system for providing media content, in accordance with an embodiment.

As illustrated in FIG. 1, in accordance with an embodiment, a media device 102, operating as a client device, can receive and play media content provided by a media server system 142 (media server), or by another system or peer device. In accordance with an embodiment, the client device can be, for example, a personal computer system, handheld entertainment device, tablet device, smartphone, television, audio speaker, in-car entertainment system, or other type of electronic or media device that is adapted or able to prepare a media content for presentation, control the presentation of media content, and/or play or otherwise present media content.

In accordance with an embodiment, each of the client device and the media server can include, respectively, one or more physical device or computer hardware resources 104, 144, such as one or more processors (CPU), physical memory, network components, or other types of hardware resources.

Although, for purposes of illustration, a single client device and media server are shown, in accordance with an embodiment a media server can support the simultaneous use of a plurality of client devices. Similarly, in accordance with an embodiment, a client device can access media content provided by a plurality of media servers, or switch between different media streams produced by one or more media servers.

In accordance with an embodiment, the client device can optionally include a display screen having a user interface 106, which is adapted to display media options, for example as an array of media tiles, thumbnails, or other format, and to determine a user interaction or input. Selecting a particular media option, for example a particular media tile or thumbnail, can be used as a command by a user and/or the client device, to the media server, to download, stream or otherwise access a corresponding particular media content item or stream of media content.

In accordance with an embodiment, the client device can also include a software media application 108, together with an in-memory client-side media content buffer 110, and a data buffering logic or software component 112, which can be used to control the playback of media content received from the media server, for playing either at a requesting client device (i.e., controlling device) or at a controlled client device (i.e., controlled device), in the manner of a remote control. A connected media environment firmware, logic or software component 120 enables the device to participate within a connected media environment.

In accordance with an embodiment, the data buffering logic, together with the media content buffer, enables a portion of media content items, or samples thereof, to be pre-buffered at a client device. For example, while media options are being prepared for display on a user interface, e.g., as media tiles or thumbnails, their related media content can be pre-buffered at the same time, and cached by one or more client devices in their media content buffers, for prompt and efficient playback when required.

In accordance with an embodiment, the media server system can include an operating system 146 or other processing environment which supports execution of a media server 150 that can be used, for example, to stream music, video, or other forms of media content to a client device, or to a controlled device.

In accordance with an embodiment, the media server can provide a subscription-based media streaming service, for which a client device or user can have an associated account and credentials, and which enable the user's client device to communicate with and receive content from the media server. A received media-access request from a client device can include information such as, for example, a network address, which identifies a destination client device to which the media server should stream or otherwise provide media content, in response to processing the media-access request.

For example, a user may own several client devices, such as a smartphone and an audio speaker, which can play media content received from a media server. In accordance with an embodiment, identifying information provided with a media-access request can include an identifier, such as an IP address, MAC address, or device name, which identifies that the media-access request is intended for use with a particular destination device. This allows a user, for example, to use their smartphone as a controlling client device, and their audio speaker as a controlled client device to which media content should be sent. The media server can then send the requested media and/or forward the media-access request to the audio speaker, even though the request originated at the user's smartphone.

In accordance with an embodiment, a media application interface 148 can receive requests from client devices, or from other systems, to retrieve media content from the media server. A context database 162 can store data associated with the presentation of media content by a client device, including, for example, a current position within a media stream that is being presented by the client device, or a playlist associated with the media stream, or one or more previously-indicated user playback preferences. The media server can transmit context information associated with a media stream to a client device that is presenting that stream, so that the context information can be used by the client device, and/or displayed to the user. The context database can be used to store a media device's current media state at the media server, and synchronize that state between devices, in a cloud-like manner. Alternatively, media state can be shared in a peer-to-peer manner, wherein each device is aware of its own current media state which is then synchronized with other devices as needed.

For example, in accordance with an embodiment, when the destination client device to which the media content is being streamed changes, from a controlling device to a controlled device, or from a first controlled device to a second controlled device, then the media server can transmit context information associated with an active media content to the newly-appointed destination device, for use by that device in playing the media content.

In accordance with an embodiment, a media content database 164 can include media content, for example music, songs, videos, movies, or other media content, together with metadata describing that media content. The metadata can be used to enable users and client devices to search within repositories of media content, to locate particular media content items.

In accordance with an embodiment, a buffering logic or software component 180 can be used to retrieve or otherwise access media content items, in response to requests from client devices or other systems, and to populate a server-side media content buffer 181, at a media delivery component/streaming service 152, with streams 182, 184, 186 of corresponding media content data, which can then be returned to the requesting device or to a controlled device.

In accordance with an embodiment, a plurality of client devices, media server systems, and/or controlled devices, can communicate with one another using a network, for example the Internet 190, a local area network, peer-to-peer connection, wireless or cellular network, or other form of network. For example, a user 192 can interact 194 with the user interface at a client device, and issue requests to access media content, for example the playing of a selected music or video item at their client device or at a controlled device, or the streaming of a media channel or video stream to their client device or to a controlled device.

In accordance with an embodiment, the user's selection of a particular media option can be communicated 196 to the media server, via the server's media application interface. The media server can populate its media content buffer at the server 204, with corresponding media content, 206 including one or more streams of media content data, and can then communicate 208 the selected media content to the user's client device, or to the controlled device as appropriate, where it can be buffered in a media content buffer for playing at the device.

In accordance with an embodiment, and as further described below, the system can include a server-side media gateway or access point 220, or other process or component, which operates as a load balancer in providing access to one or more servers, for use in processing requests at those servers. The system can enable communication between a client device and a server via an access point at the server, and optionally the use of one or more routers, to allow requests from the client device to be processed either at that server and/or at other servers.

For example, in a Spotify media content environment, most Spotify clients connect to various Spotify back-end processes via a Spotify “accesspoint”, which forwards client requests to other servers, such as sending one or more metadataproxy requests to one of several metadataproxy machines on behalf of the client or end user.

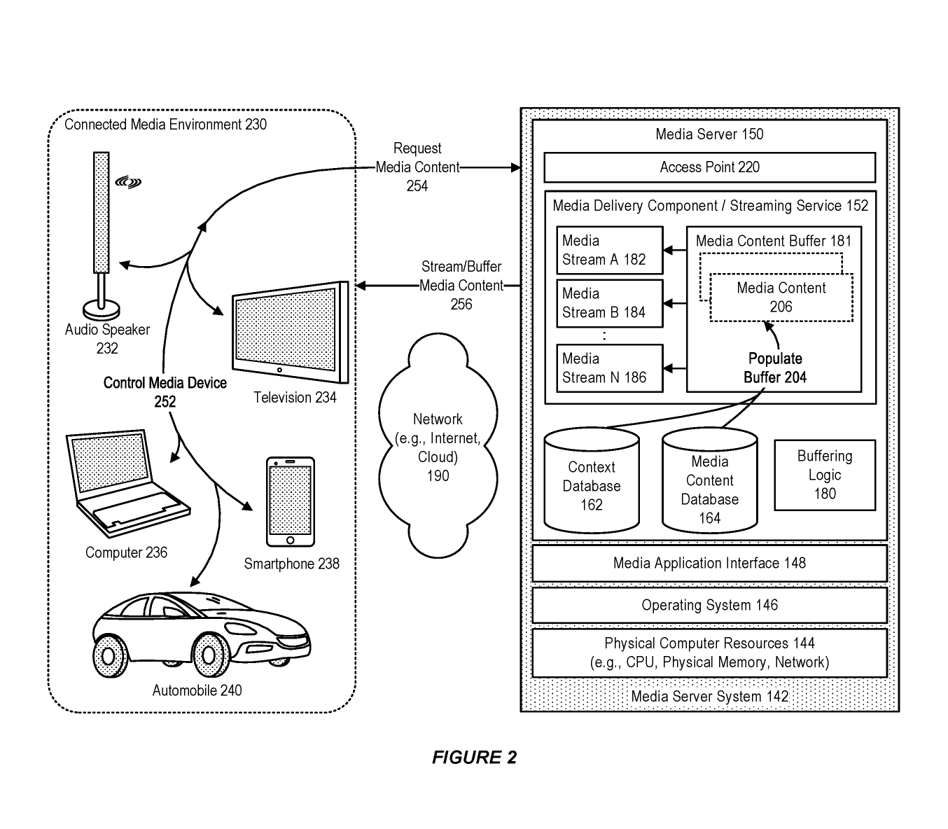

FIG. 2 further illustrates an example of a system for providing media content, in accordance with an embodiment.

As illustrated in FIG. 2, in accordance with an embodiment, a connected media environment 230, for example a Spotify Connect environment, enables communication between a client device and the server-side access point in a connected manner from the perspective of a user. Examples of the types of media device that can be provided within a connected media environment include audio speakers 232, televisions 234, computers 236, smartphones 238, and in-car entertainment systems 240, or other types of media device.

In accordance with an embodiment, a client device having an application user interface can act as a controlling client device, to control 252 the playback of media content at a controlled device. In accordance with an embodiment, a client device can itself act as a media gateway or access point, for use by other devices within the system for providing media content.

In accordance with an embodiment, a controlled device can also include a media application, which in the case of an audio speaker, television or similar device can be included within the device itself as a firmware logic or software component, or within, for example, a separate set-top box or similar after-market device.

As described above, in accordance with an embodiment, a user can interact with the user interface at a client device, and issue requests to access media content, for example the playing of a selected music or video item at their client device or at a controlled device, or the streaming of a media channel or video stream to their client device or to a controlled device.

For example, in accordance with an embodiment, a user can request that media content be buffered, streamed or received and played at a controlling client device such as a smartphone, and simultaneously buffered, streamed or received for playing at one or more controlled devices, such as an audio speaker. Similarly, for example, the user can issue a media-change request 254 to change a media channel, in response to which the media server can switch the media channel at the controlled device, and thereafter continue to stream or buffer media content 256 for the switched channel, at the controlled device.

As described above, in some instances, a portion of the media content can be pre-buffered at the controlled device, so that the switching to the channel at the controlled device operates in a seamless manner.

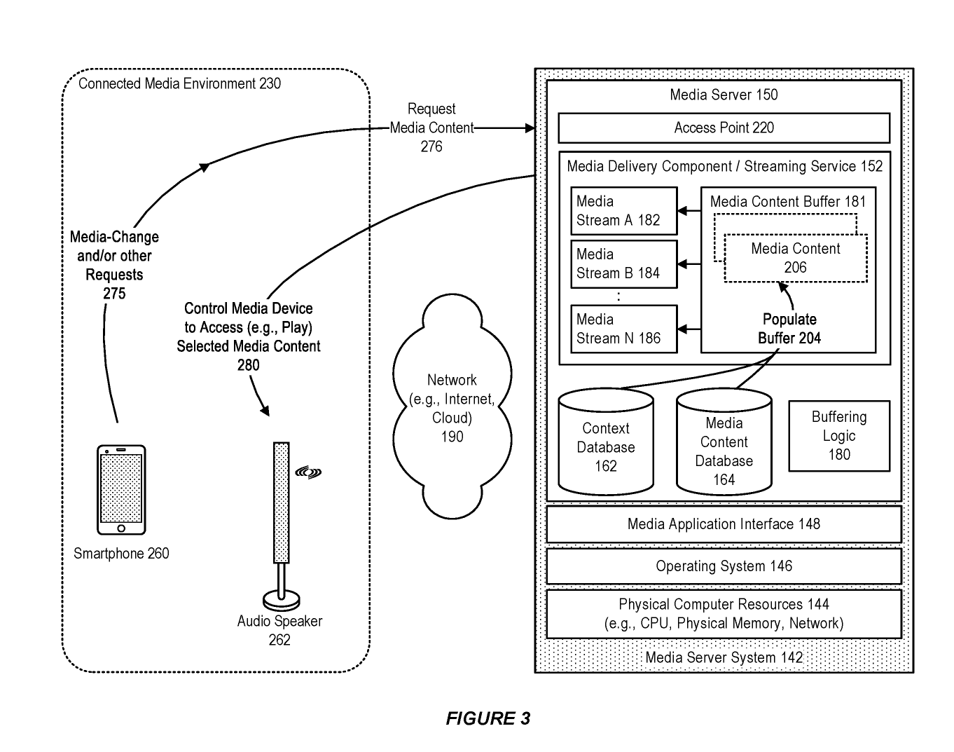

FIG. 3 further illustrates an example of a system for providing media content, in accordance with an embodiment.

As illustrated in FIG. 3, a user can utilize, for example, a smartphone 260 in combination with an audio speaker 262, to issue a media-change request 275 from the smartphone, for example, to change a media channel at the audio speaker. The request can be received by the media gateway or access point, and communicated to the local media server, or to other media servers, as a request for media content 276, which can then respond by controlling the destination device (in this example, the audio speaker) to access (e.g., play) the selected media content 280.

### Promoted Track Display

In a media content or streaming environment, content providers can use an advertisement server, for example a DoubleClick for Publishers (DFP) advertisement server, to help manage their advertising campaigns and satisfy orders from advertising partners.

For example, a content provider can cause a code or tag to be placed into a media stream, and can associate advertising orders with line-items or advertising campaigns. An advertising campaign can include a variety of advertising creatives, for example banner advertisements. When the media stream is accessed by a user's media device, for example by playing a stream of songs, the code or tag can be used by the advertisement server to select or otherwise determine which advertising campaign should be used to deliver a particular advertisement, for example based on factors such as priority, time, duration, or cost-per-thousand-impressions (CPM). In some environments, CPM-based campaigns include house ads, which are generally run by the content provider to promote their own services.

However, there is an ongoing desire for new advertising mechanisms that provide content providers and advertisers with a means of promoting content that is more effective than other formats; while providing users with, for example, music or song recommendations which they feel are relevant to their musical tastes.

In accordance with an embodiment, described herein are a system and method for providing a promoted track display for use with a media content or media streaming environment. One or more promoted tracks, for example songs, music, or other sponsor content, can be surfaced or otherwise displayed via visuals or display queues that play upon user initiation or click. Display queues for use with promoted tracks can be used to increase promoted track inventory and provide a new advertisement format for use by media content partners, for example, music promoters.

In accordance with an embodiment, promoted tracks enable a content provider, such as a music streaming service (e.g. Spotify) and/or content partners, such as music artists and labels, to promote content within the stream. The system can provide, at the user interface of a media device, a visual prompt to play or listen to a promoted track that is clearly indicated as promoted content to the user; and the track is then playable on demand or upon a user-click or other form of selection.

In accordance with an embodiment, promoted tracks can be booked as advertisement campaigns in an advertisement server, and can include, for example, granular targeting, frequency caps, click goals, and impression goals or other criteria available for the advertisement format.

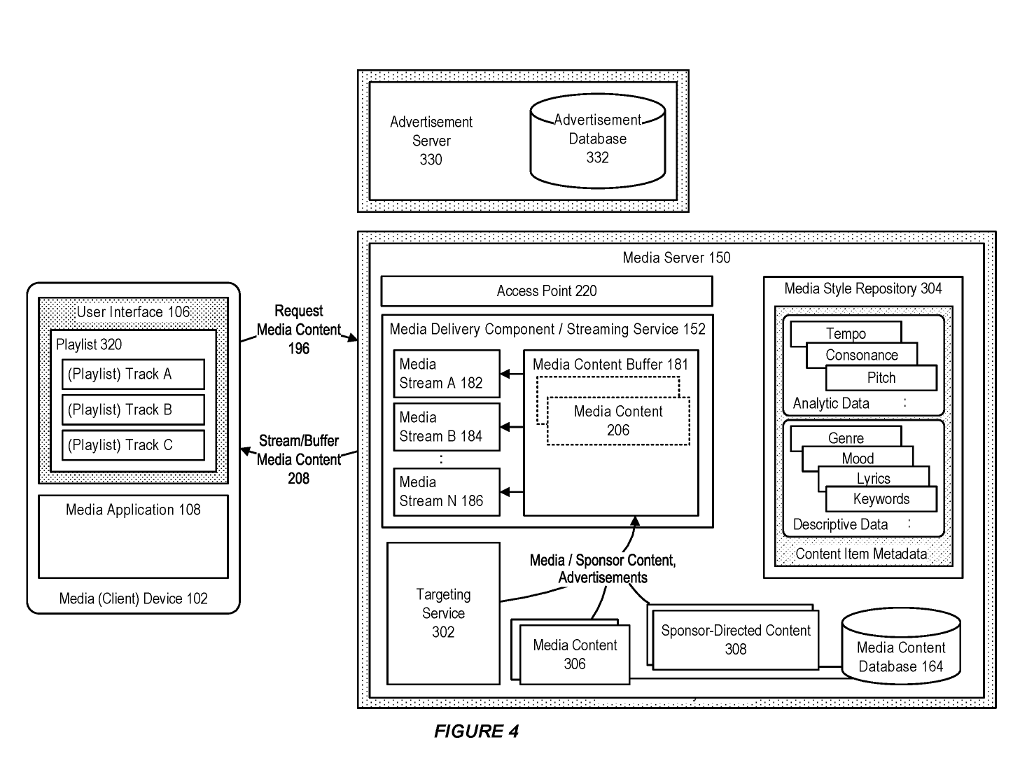

FIG. 4 illustrates a system for providing a promoted track display format in a media streaming environment, in accordance with an embodiment.

As illustrated in FIG. 4, in accordance with an embodiment, a user can interact with a media device or client (e.g., a Spotify client), and issue requests to access media content at a media server (e.g., a Spotify server), for example, to stream music, video, or other forms of media content to the media device. In response, the media server can populate a media content buffer with corresponding items of media or sponsor-directed content, for example as one or more streams of media content and/or advertisement or other sponsor-directed content, and communicate the selected media content to the user's media device.

In accordance with an embodiment, a targeting service 302 can be used to determine an appropriate advertisement or other sponsor-directed content, which can be combined or otherwise associated with a particular stream or session of media content playback.

In accordance with an embodiment, the media server can include a media style repository 304 that stores media content item metadata associated with different items of media content, for use in providing music-styled and/or contextual information about the media content.

In accordance with an embodiment, the media delivery component/streaming service, in combination with the targeting service, can determine an appropriate media content 306 and/or sponsor-directed content 308, for streaming within a particular session, for example as a playlist 320 having a plurality of tracks. This allows the system to associate a track with a user's behavior, to increase the chance that a user will engage with the content, and also supports reaching a new audience, or maximizing exposure for a particular piece of content, for example by delivering it to those people who are most likely to find it engaging.

In accordance with an embodiment, an advertisement server 330, for example a DoubleClick for Publishers (DFP) advertisement server, together with an advertisement database 332, to help manage a content provider's advertising campaigns and satisfy orders from advertising partners.

In accordance with an embodiment, from the user experience, when, for example, looking for playlists or songs to play at their media device, the user interface can display an offering of one or more promoted tracks 340. If the user-clicks or otherwise selects a promoted track they can have it played on demand (rather than, for example having to wait for it to be played as part of a playlist in shuffle mode). The promoted track display differentiates its promoted content from the regular or standard set of, e.g., playlist tracks.

In accordance with an embodiment, the system can match a promoted track, for example, to a playlist that is relevant or to a type of user that is relevant. For example, a hip-hop artist may be targeted for promotion to listeners of a hip-hop playlist. In accordance with an embodiment, the system can automatically match a promoted track to a type of music, for example based on metadata or an analysis of the promoted track. Depending on the particular embodiment, users may either elect to opt in to receive the promoted track, or in some embodiments the promoted track can be automatically shuffled into the playlist.

In accordance with an embodiment, when a promoted track is selected for play, the user-click or selection directly associated with the promoted track provides a direct feedback to the advertiser. The system can also tie a secondary action to the playing of a promoted track, and tie those impressions together. Plays can be optimized against delivery and skip rate. For example, if it determined that some users are skipping through a particular track, while other users are saving that track, this type of information can be used to determine the success of a particular promotion.

In accordance with an embodiment, when a client media device is playing a music and using a tag to identify an advertisement or other promoted content, the tag can be used to retrieve the advertisement or promoted content directly from an advertisement server, or from a media content server. Typically the client makes a call 342 to an advertisement server requesting for an ad. In accordance with an embodiment, since the media content is stored on the media server, including in many instances the promoted track media content, the external advertisement server can be used to determine which advertisement to use, and then use redirection to cause the client to retrieve the appropriate content.

For example, in accordance with an embodiment, if the client informs the advertisement server that it intends to show a prompted track, the advertisement server can determine which track to promote and delivers a code/tag 344 back to the client, which the client can then use to request 350 the corresponding track from the media server, to be streamed or otherwise provided 352 to the media device. In such embodiments, the external advertisement server can be responsible for the selection process, with the media server responsible for receiving the requests from the clients and delivering the requested promoted track.

In accordance with an embodiment, a media content provider (e.g., Spotify) advertising specialist can provide a set of track ID's to the advertising server, and the advertising sever can then return the code to the client indicating the client to, e.g., retrieve a particular track ID in response to a click on a particular promoted track. In some embodiments, a tool can be provided to configure the campaign to do the promotion.

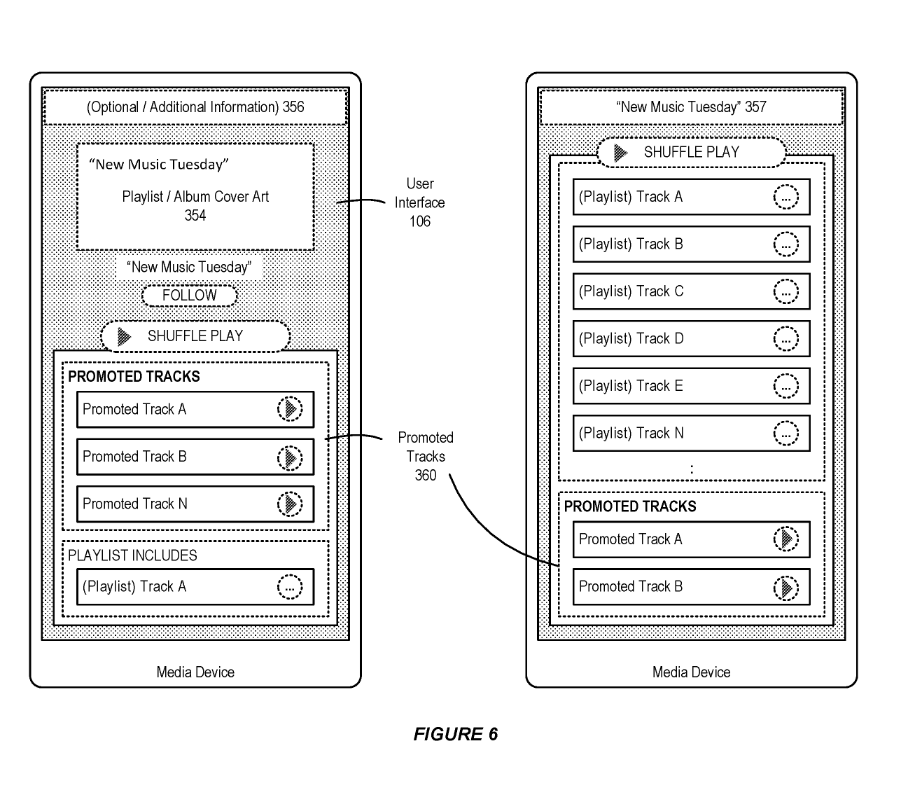

FIG. 6 illustrates an exemplary promoted track display for use with a media content or streaming environment, in accordance with an embodiment.

As illustrated in FIG. 6, which illustrates a playlist as it might appear on a user's media device, including in this example a playlist/album cover art 354, and optional or additional information 356, such as the playlist name 357, the one or more promoted tracks 360 are clearly indicated as being promoted content, and are playable on demand upon a user-click or other form of selection from within a playlist view. For example, this can be a paid advertisement product available on a CPM or cost-per-click (CPC) basis. Label advertisement credit can be used to purchase the product, or labels/promoters/marketers can purchase it in a direct sold basis.

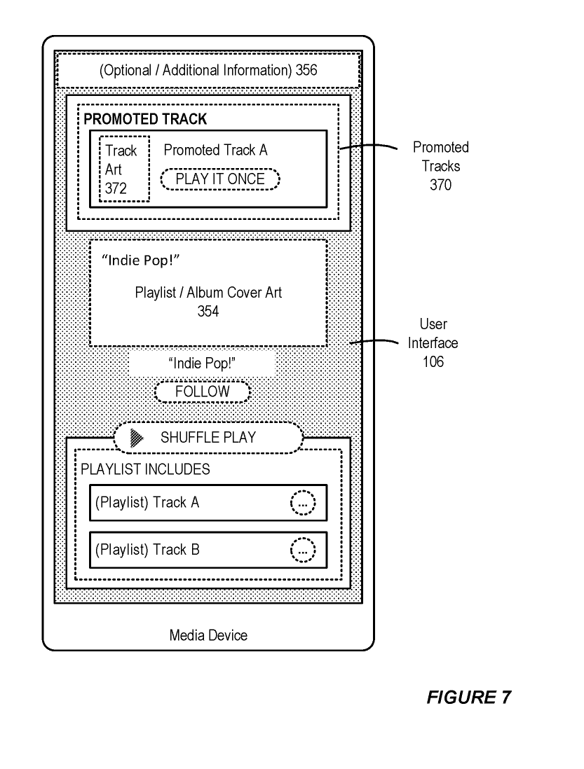

FIG. 7 illustrates another exemplary promoted track display for use with a media content or streaming environment, in accordance with an embodiment.

As illustrated in FIG. 7, in accordance with an embodiment, a promoted track 370 can be displayed at the top of the screen and can include a track art 372. For example, the promoted track can be configured so that a video advertisement appears after clicking on a playlist. Some playlists may not be associated with a promoted track. Once the user plays the promoted track it is no longer displayed upon selecting that playlist.

### Targeting, Tracking and Reporting

In accordance with an embodiment, the system can leverage existing location and demographic targeting along with new behavioral vectors, for example realtime genre, historic genre, playlist and artist similarity.

In accordance with an embodiment, reporting and downstream attribution and tracked metrics can include, for example: impressions—total promoted tracks served; plays—impressions streamed for greater than 30 seconds; clicks—clicks on companion banner; post plays—follow on plays from exposed users; saves—saves generated from a campaign; follows—follows generated from a campaign; shares—shares generated from a campaign; or playlist additions—generated from a campaign.

In accordance with an embodiment, advertisement operations can be streamlined requiring little more than track ID, play count goal and click through option to traffic. An advertisement creative can be generated from existing track and album art. Targeting can be based on relevancy to user, listening context and optimized against delivery (skip rate), which contribute to making the trafficking self-serve and the pricing dynamic.

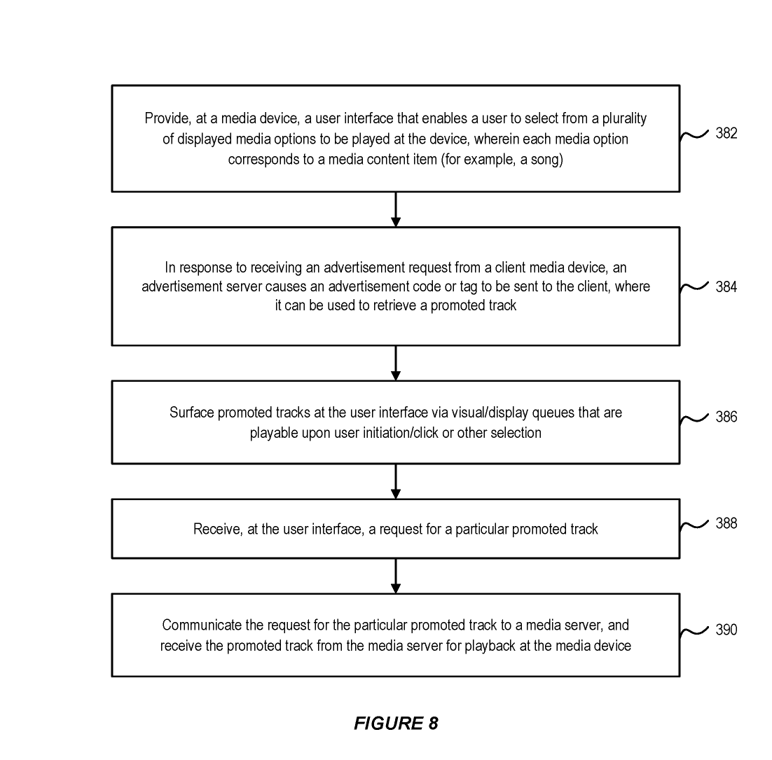

FIG. 8 illustrates a process for providing a promoted track display for use with a media content or streaming environment, in accordance with an embodiment.

As illustrated in FIG. 8, in accordance with an embodiment, at step 382, a user interface is provided at a media device, that enables a user to select from a plurality of displayed media options to be played at the device, wherein each media option corresponds to a media content item (for example, a song).

At step 384, in response to receiving an advertisement request from a client media device, an advertisement server causes an advertisement code or tag to be sent to the client, where it can be used to retrieve a promoted track.

At step 386, promoted tracks are surfaced at the user interface via visual/display queues that are playable upon user initiation/click or other selection.

At step 388, at the user interface, a request is received for a particular promoted track.

At step 390, the request for the particular promoted track is communicated to a media server, and the promoted track received from the media server for playback at the media device.

### Use Cases and Advantages

In accordance with various embodiments, benefits include to content owners: a new means of promoting content that's likely more effective than other formats; to users: promoted track recommendations that are actually relevant and useful; to content provider, a potential to shift advertisement credit out of commercially available advertisement formats; and to content owners: an ability to reach both large audiences and niche groups of fans using the system's targeting capabilities.

Embodiments of the present invention may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a non-transitory storage medium or computer readable medium (media) having instructions stored thereon/in which can be used to program a computer to perform any of the processes of the present invention. Examples of the storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of embodiments of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated.

What is claimed is:

1. A system for providing a promoted track display in a media content environment, comprising:
a media device having a user interface, that enables a user to select from a plurality of displayed media options to be played at the device, wherein each media option corresponds to a media content item;
wherein in response to receiving an advertisement request from a client, an advertisement server causes an advertisement code or tag to be sent to the client, where it can be used to retrieve a promoted track; and
wherein one or more promoted tracks are surfaced at the user interface via visual/display queues that are playable upon user initiation/click or other selection.

2. The system of claim 1, wherein a user can interact with a media device or client, and issue requests to access media content at a media server to stream music, video, or other forms of media content to the media device; and
wherein in response, the media server can populate a media content buffer with corresponding items of media or sponsor-directed content, for example as one or more streams of media content and/or advertisement or other sponsor-directed content, and communicate the selected media content to the user's media device.

3. The system of claim 1, wherein the system includes a targeting service that can determine an appropriate media content and/or sponsor-directed content, for streaming within a particular session.

4. The system of claim 1, wherein the system can match a promoted track to a playlist that is relevant or to a type of user that is relevant.

5. A method of providing a promoted track display in a media content environment, comprising:
providing, at a media device, a user interface, that enables a user to select from a plurality of displayed media options to be played at the device, wherein each media option corresponds to a media content item;
wherein in response to receiving an advertisement request from a client, an advertisement server causes an advertisement code or tag to be sent to the client, where it can be used to retrieve a promoted track; and
wherein one or more promoted tracks are surfaced at the user interface via visual/display queues that are playable upon user initiation/click or other selection.

6. The method of claim 5, wherein a user can interact with a media device or client, and issue requests to access media content at a media server to stream music, video, or other forms of media content to the media device; and
wherein in response, the media server can populate a media content buffer with corresponding items of media or sponsor-directed content, for example as one or more streams of media content and/or advertisement or other sponsor-directed content, and communicate the selected media content to the user's media device.

7. The method of claim 5, wherein the system includes a targeting service that can determine an appropriate media content and/or sponsor-directed content, for streaming within a particular session.

8. The method of claim 5, wherein the system can match a promoted track to a playlist that is relevant or to a type of user that is relevant.

9. A non-transitory computer readable storage medium, including instructions stored thereon which when read and executed by one or more computers cause the one or more computers to perform the steps comprising:
providing, at a media device, a user interface, that enables a user to select from a plurality of displayed media options to be played at the device, wherein each media option corresponds to a media content item;
wherein in response to receiving an advertisement request from a client, an advertisement server causes an advertisement code or tag to be sent to the client, where it can be used to retrieve a promoted track; and
wherein one or more promoted tracks are surfaced at the user interface via visual/display queues that are playable upon user initiation/click or other selection.

10. The non-transitory computer readable storage medium of claim 9, wherein a user can interact with a media device or client, and issue requests to access media content at a media server to stream music, video, or other forms of media content to the media device; and
wherein in response, the media server can populate a media content buffer with corresponding items of media or sponsor-directed content, for example as one or more streams of media content and/or advertisement or other sponsor-directed content, and communicate the selected media content to the user's media device.

11. The non-transitory computer readable storage medium of claim 9, wherein the system includes a targeting service that can determine an appropriate media content and/or sponsor-directed content, for streaming within a particular session.

12. The non-transitory computer readable storage medium of claim 9, wherein the system can match a promoted track to a playlist that is relevant or to a type of user that is relevant.
